(19) United States
(12) Patent Application Publication
(10) Pub. No.: US 2010/0066119 A1
(43) Pub. Date: Mar. 18, 2010

(54) Protective Decorative Cover For Child Strollers, Tricycles and Bicycles

(76) Inventors: Donielle M. Levine, Toluca Woods, CA (US); Jennifer Cole Fenton, Toluca Woods, CA (US)

Correspondence Address: HOLLAND & KNIGHT LLP, 633 WEST FIFTH STREET, TWENTY-FIRST FLOOR, LOS ANGELES, CA, 90071-2040, US

(21) Appl. No.: 12/562,758

(22) Filed: Sep. 18, 2009

Related U.S. Application Data
(60) Provisional application No. 61/192,481, filed on Sep. 18, 2008.

(51) Int. Cl. B60J 7/00

(52) U.S. Cl. 296/136.07

(57) ABSTRACT

A decorative protective cover for providing a neat fitment about one of a plurality of differently sized and shaped child strollers, tricycles or bicycles. The cover comprises laterally spaced side panels, a rear panel and a front panel that are shaped and secured together to define the cover and a shape such that when the cover is disposed over and about the stroller, tricycle or bicycle and lateral rear end portions of the side panels are drawn together, the cover fits neatly about the stroller, tricycle or bicycle. Ties are preferably provided proximate laterally spaced rear edge portions of the side panels that cooperate to draw the rear edge portions of the side panels toward one another and secure the rear edge side panel portion in place to provide an attractive securement of the cover in a neat fitment about the stroller, tricycle or bicycle.

### CROSS-REFERENCE TO RELATED APPLICATIONS

This application claims the benefit of U.S. Provisional Patent Application No. 61/192,481, filed Sep. 18, 2008 entitled “Protective Decorative Cover For Child Strollers, Tricycles and Bicycles”.

### BACKGROUND OF THE INVENTION

The present invention relates to a decorative protective cover particularly adapted for use with baby or child strollers. Child strollers are often relatively bulky, making indoor storage difficult when space is at a premium. As a result, they are frequently stored out-of-doors where they are subject to the elements and become quickly soiled. To protect the stroller, a tarp or plastic sheet is often placed over or wrapped about the stroller. However, such covers generally do a poor job of protecting the stroller and are unsightly. The covers themselves are relatively bulky and awkward to handle and store.

Child strollers are manufactured in a wide variety of sizes and shapes. Thus, if one were to design a decorative form fitting cover for a particular stroller, it likely would not fit a different stroller model. To the extent that it did, it is unlikely that the intended form fit would be obtained and the desired attractive appearance would be lost or substantially diminished. As a result, to provide a neat and attractive outdoor protective cover for strollers would almost require a particularly configured cover for each stroller design. Because of the resultant costs, such covers are not readily available. The present invention, however, provides such a cover. While particularly adapted for child strollers, the cover of the present invention can also be used with children's tricycles, bicycles and other objects.

### SUMMARY OF THE INVENTION

Briefly, the present invention is directed to a decorative protective cover that is particularly configured to neatly fit about a wide variety of differently sized and shaped baby or child strollers. The cover is comprised of a pair of opposed side panels, each having a relatively straight and slightly rearwardly inclined rearward end, a generally horizontal lower end, a slightly inclined upper end merging along a curvilinear path into a downwardly and outwardly inclined forward end. Extending between the side panels is a substantially rectangular panel that is preferably sewn along its lateral ends to the forward and upper ends of the side panels. A generally rectangular rear panel is similarly sewn along its lateral ends to the rear ends of the side panel and at its upper end to the rear of the front panel. A tie is preferably provided at the rear of the cover for drawing together the rearward ends of the side panels about the rear panel, conforming the cover to the size and configuration of the stroller disposed therein and thereby neatly securing the cover about the stroller. The individual panels are preferably formed of a decorative material that allows the panels to be readily sewn together and provide a flexible cover that is water proof, easy to clean and fold, durable and easy to hold. A decorative oil cloth free of phthalate DEHP is an example of such a material.

The above described configuration has been found to provide an attractive protective cover that snugly and attractively fits about strollers of a variety of sizes and shapes to protect the stroller from the weather while continuing to present a neat appearance.

### BRIEF DESCRIPTION OF THE DRAWINGS

FIG. 1 is a perspective view of the cover of the present invention in a fully open position as though disposed over a child's stroller, tricycle or bicycle.

FIG. 2 is a perspective view of the cover of the present invention in an open and secured position as though disposed over and secured about a child's stroller, tricycle or bicycle.

FIG. 3 is perspective view of the cover of the present invention as seen from the rear side thereof and illustrating the use of ties for drawing rearward end portions of the side panels toward one another and securing the cover about a stroller, tricycle or bicycle to provide a neat attractive fitment of the cover about the covered item.

FIG. 4A is a side view of one of the side panels of the cover of the present invention.

FIG. 4B is a side view of the side panel of the cover of the present invention opposite the panel illustrated in FIG. 4A.

FIG. 5 is an exploded perspective view of the panels comprising the cover of the present invention.

FIG. 6 is a perspective view in dotted lines of a first stroller.

FIG. 7 is a side view of the cover of the present invention disposed over and secured about the stroller of FIG. 6.

FIG. 8 is a perspective view in dotted lines of a second stroller.

FIG. 9 is a side view of the cover of the present invention disposed over and secured about the stroller of FIG. 8.

FIG. 10 is a rear view of the cover of the present invention in a rolled storage mode.

FIG. 11 is a perspective view of a variety of sizes and shapes of child strollers.

### DETAILED DESCRIPTION OF THE PREFERRED EMBODIMENT

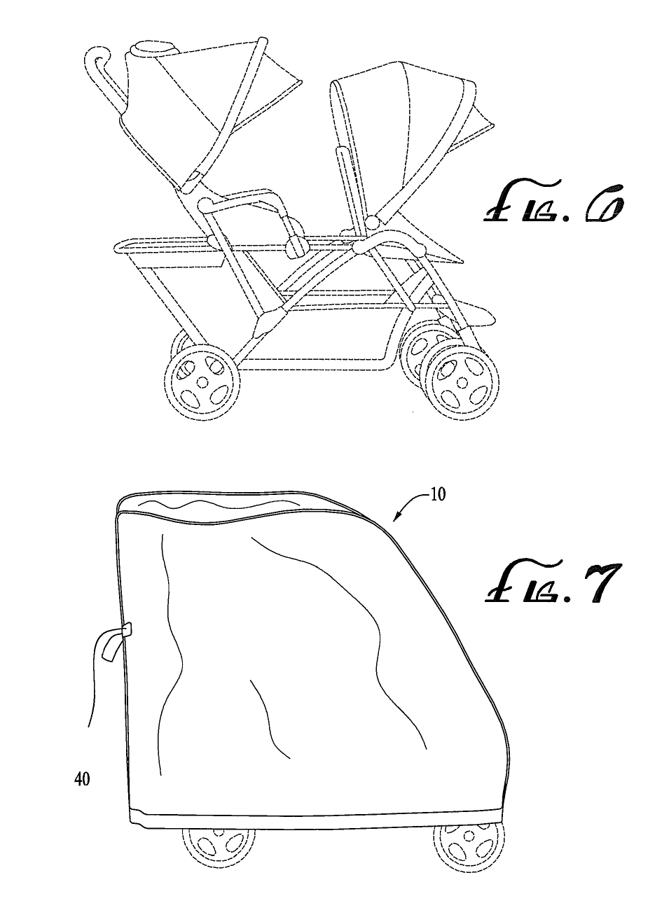

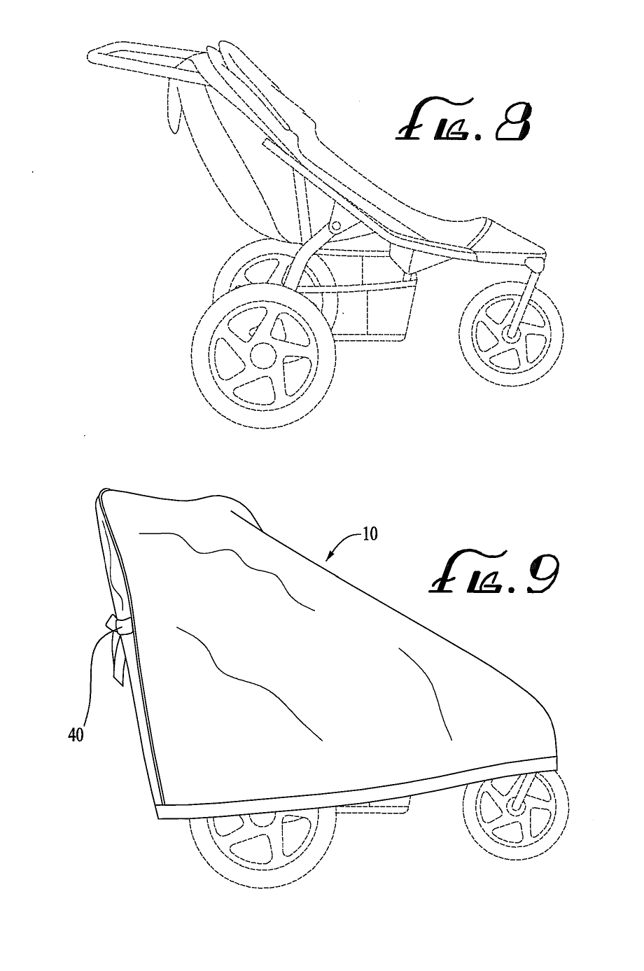

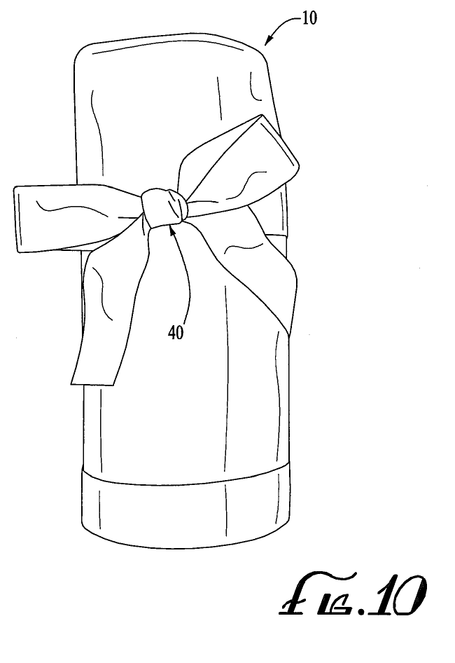

Referring now in detail to the drawings, a preferred embodiment of the cover 10 of the present invention is comprised of a pair of side panels 12, a front panel 14 and a rear panel 16. The panels are joined together along their adjacent edges, preferably sewn together, and the joined seams are preferably covered with a decorative piping 18. The side panels 12 are mirror images of each other as illustrated in FIGS. 4A and 4B. As seen therein, each side panel defines a rearward end 20, upper end 22, forward end 24 and lower end 26. The rearward ends of both side panels 12 are generally linear and inclined slightly rearwardly as seen in FIGS. 4A and 4B. The upper rear corners 28 of the side panels 12 are tightly radiused such that the upper end 22 of the side panels extends forwardly and at a slight downward inclination and merges into a downwardly and outwardly inclined forward end 24 along a more gradually radiused turn 25 at the upper forward end portions of the panels. The lower ends 26 of the side panels are generally horizontal.

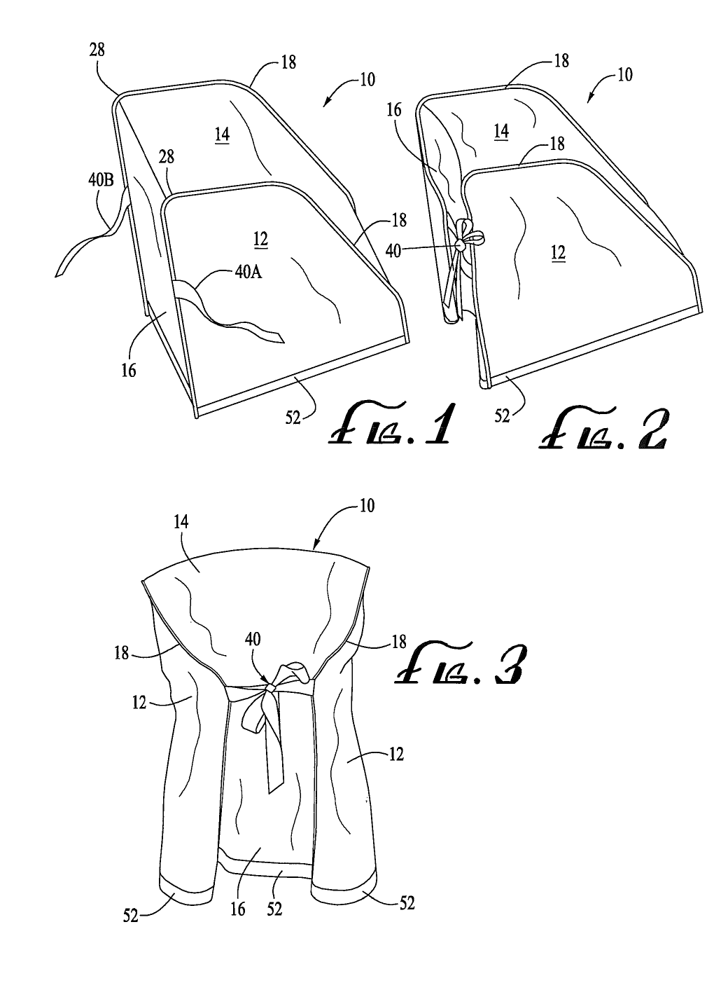

The front panel 14 is of a rectangular configuration and is preferably sewn along its lateral ends 30 to the forward and upper ends of the side panels as seen, for example, in FIGS. 1 and 2. Again, the seams preferably are covered by a decorative piping 18. The rear panel 16 also is of a rectangular configuration and extends between and is joined to the rearward ends 20 of the side panels and the rearward end 32 of the front panel 14, again, the panels are preferably sewn together and piping 18 is again preferably provided over the sewn seams. Alternatively, the front panel 14 could comprise two generally rectangular panels (not shown), one of the panels would define a front panel and the other a top or upper panel. The two panels would be joined together and thus define the same overall configuration as panel 14. While, this alternate embodiment would use less material, the resulting economic savings may be offset by higher labor costs as there would be additional panel edge portions to be joined together. The functioning and performance of the alternate embodiments should be the same.

The resulting cover 10 extends upwardly and slightly rearwardly along the rear side thereof, has opposed vertical sides and extends from the upper rear end thereof forwardly and at a slight downward inclination therefrom and curving downwardly along the forward upper end portion thereof along a steep vertical inclination. This configuration has been found to conform to the overall configuration of a wide variety of strollers of varying sizes and designs as is illustrated in FIG. 11. While strollers do vary significantly in size and design, they generally have a slight rearward inclination, define a generally horizontal or slightly declining upper surface extending from the push handle at the rear of the stroller over the top of the protective bonnet and then extend downwardly along a somewhat curvilinear path into a relatively steep inclination extending over the forward wheels. Thus, the above-described cover configuration corresponds to this general stroller configuration while accommodating the various sizes and shapes defined by these strollers.

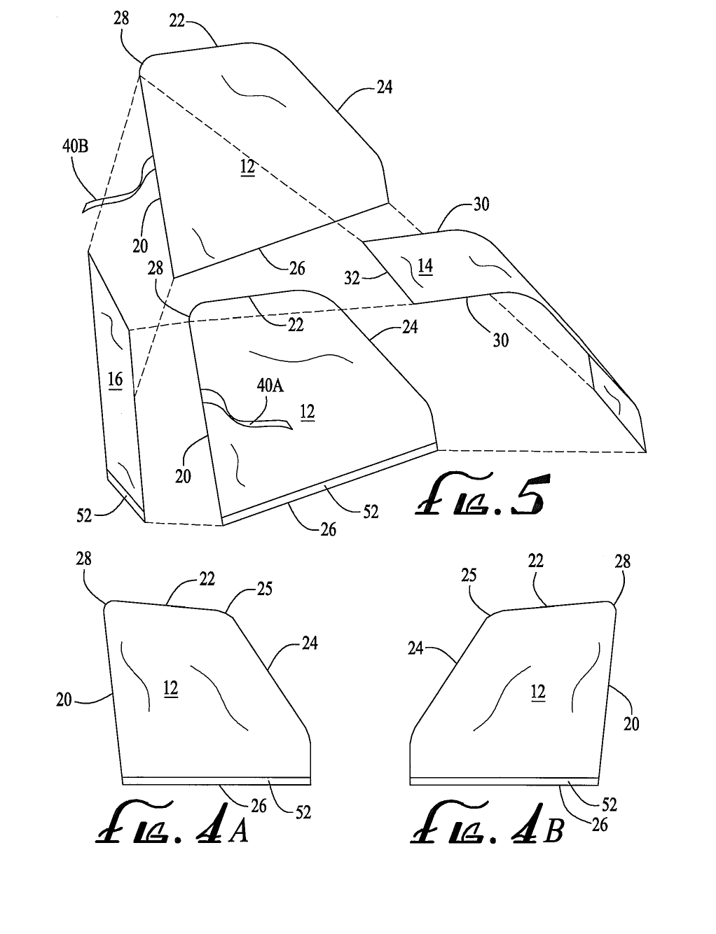

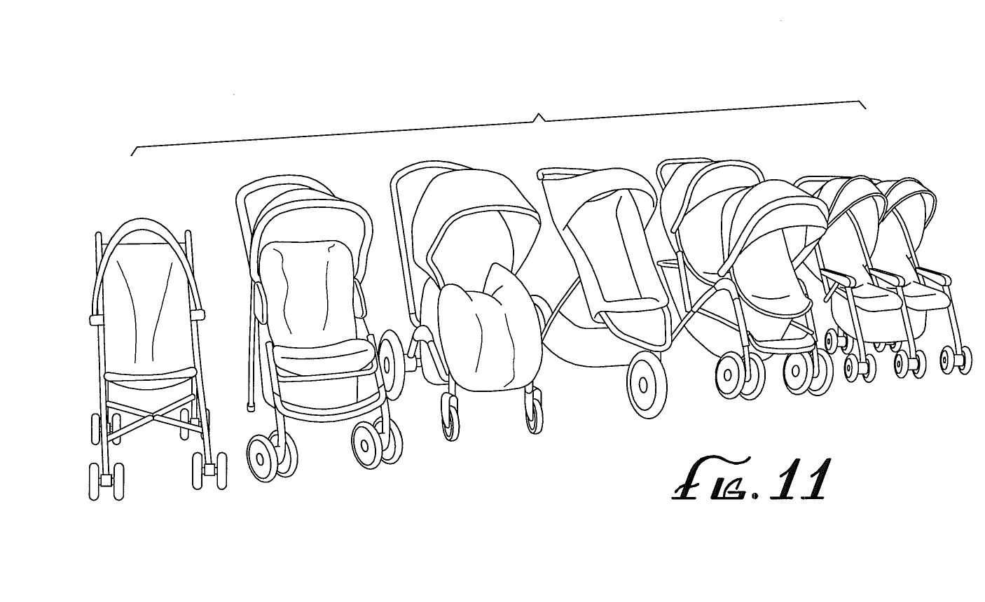

To tailor the cover 10 to the particular size and design of the stroller to be covered, a tie 40 is provided at the rear of the cover. The tie 40 is preferably comprised of two lengths of flexible material 40A and 40B that are sewn to the cover at opposed lateral locations adjacent to the seams formed between the two side panels 12 and the rear panel and approximately two-thirds of the distance from the lower end of rear panel 16 to the extended upper end thereof, as seen in FIG. 3. Thus, upon placing the cover over the stroller and pulling the two lengths of materials 40A and 40B together, the rearward ends 20 of the side panels 14 are pulled toward one another over the rear cover panel 16, configuring the cover to the stroller. Upon tying the two lengths together, the cover is secured about the stroller such that it will not be dislodged or blown off by wind or rain and is maintained in a neat disposition about the cover to provide an attractive appearance. See FIG. 3. Tie 40 thus allows the cover 10 to be secured snugly in place about the stroller regardless of the size or shape of the stroller due to its inherent adjustability. Tie 40 can also be used to secure the cover in a tight rolled disposition for storage (the storage mode) as shown in FIG. 10. It is to be understood, however, that other means could be employed for drawing the rearward ends of the side panels toward one another to effect the attractive securement of the cover about the stroller. As shown in FIG. 3, the use of ties formed of a wide durable, attractive and fade resistant material such as polyester grosgrain ribbon so as to provide an attractive appearance for the cover 10. A hem 52 can be foamed of the same material as tie 40 and provided about the lower end of the cover, if desired, as shown in the drawings.

While the above-described preferred embodiment of cover 10 is particularly adapted for use with baby or child strollers, it is to be understood that cover 10 could also be utilized with tricycles and bicycles and, again, attractively cover a wide variety of designs. Such uses, however, may require alternative sizes of the cover. A single size cover, however, has been found suitable for strollers of all conventional sizes and configurations as above described.

Although the present invention has been described by way of exemplary embodiments, it should be understood that many changes and substitutions may be made by those skilled in the art without departing from the spirit and the scope of the present invention, which is defined by the appended claims.

What is claimed is:

1. A decorative protective cover for providing a neat fitment about one of a plurality of differently sized and shaped strollers, said cover comprising: a pair of laterally spaced side panels defining upstanding rear edge portions, said rear edge portions merging into laterally spaced forwardly extending and declining upper edge portions, said upper edge portions merging into steeply declining frontal edge portions; a rear panel secured to and extending between said rear edge portions of said side panel; a front panel secured to and extending from an upper edge portion of said rear panel along and between said forwardly extending and declining upper edge portions and said steeply declining frontal edge portions of said side panels so as to define a cover having an open lower end, said panels being formed of a decorative and flexible material, and including means carried by said side or rear panels proximate said laterally spaced upstanding rear edge portions of said side panels for drawing said rear edge portions of said side panel toward one another over portions of said rear panel upon said cover being disposed over a stroller and securing said rearward end portions of said side panels in a fixed disposition to provide an attractive securement of said cover about the stroller.

2. The cover of claim 1 wherein the drawing means comprises a pair of flexible ties, one of said ties being secured proximate each of each rear edge portions of said side panels such that the operative connection of said ties provides a securement of said cover about a stroller in an operative mode and a tight rolled securement of said cover in a storage mode.

3. The cover of claim 1 wherein said panels are formed of a decorative oil cloth.

4. The cover of claim 2 wherein said front panel defines a first portion extending forwardly from an upper end of said rear panel at a slight downward inclination, a second portion extending forwardly and downwardly from said first portion at a steeper inclination than said first portion and a third portion extending downwardly from said second portion at a steeper inclination than said second portion.

5. The cover of claim 2 wherein said rear panel in a fully extended disposition defines an upper end and a lower end and said ties are secured to said cover at laterally spaced locations approximately two-thirds of the distance from said lower end to said upper end of said rear panel.

6. The cover of claim 2 wherein said ties are comprised of decorative ribbon.

7. The cover of claim 4 wherein said first portion of said front panel merges into said second portion thereof along a curvilinear surface.

8. The cover of claim 4 wherein said front panel is of two-piece construction, said first portion thereof defining a first subpanel and said second and third portions defining a second subpanel, said subpanels being secured together along adjacent end portions.

9. The cover of claim 4 wherein said panels are formed of a decorative oil cloth.

10. A decorative protective cover for providing a neat fitment about one of a plurality of differently sized and shaped strollers, tricycles or bicycles said cover comprising: a pair of laterally spaced side panels defining upstanding rear edge portions, said rear edge portions merging into laterally spaced forwardly extending and declining upper edge portions, said upper edge portions merging into steeply declining frontal edge portions; a rear panel secured to and extending between said rear edge portions of said side panel; a front panel secured to and extending from an upper edge portion of said rear panel along and between said forwardly extending and declining upper edge portions and said steeply declining frontal edge portions of said side panels so as to define a cover having an open lower end, said panels being formed of a decorative and flexible material, and including a pair of flexible ties, one of said ties being secured proximate each of said rear edge portions of said side panels for drawing said rear edge portions of said side panel toward one another over portions of said rear panel upon said cover being disposed over a stroller, tricycle or bicycle such that the operative connection of said ties secures said rearward end portions of said side panels in a fixed disposition to provide an attractive securement of said cover about the stroller, tricycle or bicycle and provides a tight rolled securement of said cover in a storage mode.

11. The cover of claim 10 wherein said panels are formed of a decorative oil cloth.

12. The cover of claim 10 wherein said rear panel in a fully extended disposition defines an upper end and a lower end and said ties are secured to said cover at laterally spaced locations approximately two-thirds of the distance from said lower end to said upper end of said rear panel.

13. The cover of claim 10 wherein said front panel defines a first portion extending forwardly from an upper end of said rear panel at a slight downward inclination, a second portion extending forwardly and downwardly from said first portion at a steeper inclination than said first portion and a third portion extending downwardly from said second portion at a steeper inclination than said second portion.

14. The cover of claim 12 wherein said panels are formed of a decorative oil cloth.

15. The cover of claim 13 wherein said first portion of said front panel merges into said second portion thereof along a curvilinear surface.

16. The cover of claim 13 wherein said front panel is of two-piece construction, said first portion thereof defining a first subpanel and said second and third portions defining a second subpanel, said subpanels being secured together along adjacent end portions.

17. The cover of claim 13 wherein said rear panel in a fully extended disposition defines an upper end and a lower end and said ties are secured to said cover at laterally spaced locations approximately two-thirds of the distance from said lower end to said upper end of said rear panel.
